(19) United States
(12) Patent Application Publication
(10) Pub. No.: US 2005/0224162 A1
(43) Pub. Date: Oct. 13, 2005

(54) Method and system for folding a textile strip section, especially a section of strip labels

(76) Inventor: Bernhard Engesser, Gossau (CH)

Correspondence Address: OSTROLENK FABER GERB & SOFFEN, 1180 AVENUE OF THE AMERICAS, NEW YORK, NY, 100368403, US

(21) Appl. No.: 10/517,567

(22) PCT Filed: Jun. 12, 2003
(86) PCT No.: PCT/CH03/00373

§ 371 Date: Dec. 9, 2004

(30) Foreign Application Priority Data
Jun. 13, 2002 (CH) 1005/02

(51) Int. Cl. B32B 31/00

(52) U.S. Cl. 156/227; 156/443

(57) ABSTRACT

The invention relates to a method and a system for folding a textile strip section (2), especially a section of strip labels. Said invention and system are provided with means for improving the folding quality of the strip section (2) and for protecting the system with a heating device (12), for heating the rear side of the strip section before the folding thereof.

### TECHNICAL FIELD

The invention relates to a method of folding a textile strip section, especially a section of strip labels, according to the preamble of claim 1, and also to a system for implementing the method according to claim 3.

### PRIOR ART

Methods and systems of the type mentioned at the beginning are known many times, for example from U.S. Pat. No. 3,148,874 and so on. In the methods and systems, fixing of the folded strip section is generally carried out only after folding and in the folded state. This has the disadvantage that fixing takes up a relatively great deal of time and, moreover, there is the risk that the strip section will be given glossy points on the visible side, which are produced by the pressing and heating of the folded strip, in particular when excessively intense heating has taken place. For the purpose of improvement, U.S. Pat. No. 3,148,874 has provided for the folding region to be heated on the front side before folding. Apart from the fact that heating the front side of the strip section leads to glossy points on the strip section, the heating is not sufficient to ensure satisfactory folding, in particular in the case of relatively thick strips.

### SUMMARY OF THE INVENTION

It is an object of the invention to improve a method and a system for folding a textile strip section, in particular a section of strip labels of the type mentioned at the beginning.

According to the invention, this object is achieved by
a. a method as claimed in claim 1
b. a system as claimed in claim 3.

The fact that the strip section to be folded is heated on the rear side of the region to be folded before folding means that the strip section to be folded comes into the folding device already pre-heated, which results in substantial advantages. The pre-heated strip section needs a shorter period of heating for fixing in the folding station and, moreover, this does not have to be carried out with a limiting temperature. As a result, not only is the passage time in the folding and fixing station reduced, but also the quality of the folded strip section is improved since, even at a relatively high temperature and with possible formation of gloss and/or discoloration on the rear, there is no impairment of the strip section on the visible side. Thus, even in the case of relatively thick strips, satisfactory folding and fixing of the folded strip sections can be carried out. The visible side of the strip section thus experiences gentle treatment which improves the quality. The more intensely the pre-heating is carried out, the lower is the supply of heat needed during the subsequent fixing. Finally, the folding device is also less highly stressed and is therefore subject to less wear, which leads to a longer lifetime.

Advantageous refinements of the method are contained in claim 2 and of the system in claims 4 to 7.

According to claim 2, the pre-heating can be carried out approximately as far as the softening point of the strip material.

The system for implementing the method expediently has a heating device placed upstream of the folding device in order to heat up the folding region of the strip section on the rear of the latter. The heating device can be arranged at a certain distance from the folding station. A formation of the system as claimed in claim 4 is advantageous, according to which the folding device is assigned a supporting element for the strip section per folding region. According to claim 5, the supporting element can be assigned a holding element which can be fed against the latter in order to hold the strip section on the supporting element. According to claim 6, the supporting element and/or the holding element can advantageously be equipped with an electric heating device. The system can have a specific feed device for the strip section to the folding device which, according to claim 7, is equipped with a heating device for heating the folding region of the strip section.

### BRIEF DESCRIPTION OF THE DRAWINGS

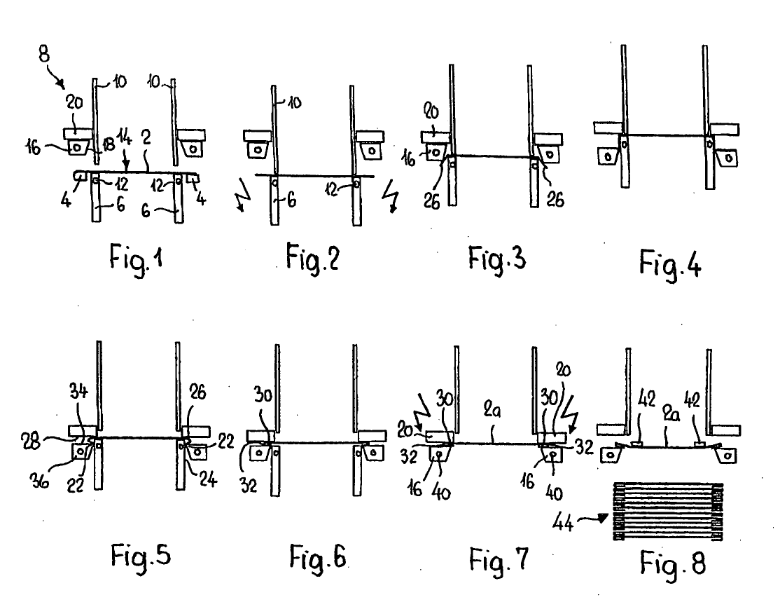

Exemplary embodiments of the invention will be described in more detail below by using schematic drawings; here, FIGS. 1 to 8 show a system for folding a strip section in a schematic illustration and in various phases of the folding of the strip section. Such a system forms the subject of WO 01/66343 and is explained in detail there. In the following text, only the parts relevant to the present invention will be described.

### WAYS OF IMPLEMENTING THE INVENTION

FIGS. 1 to 8 show a strip section 2, which has been fed over rails 4 arranged in pairs to supporting elements 6 upstream of a folding device 8. The supporting elements 6 are assigned holding elements 10, which can be pressed against the supporting elements 6 in order to hold the strip section 2 firmly on the supporting elements. The supporting elements 6 arranged at the two ends of the strip section 2 in the folding region are equipped with a heating device 12 in order to heat the strip section in the folding region on the side facing away from the visible side 14. Alternatively or additionally, the rails 4 and/or the holding element 10 can be equipped with a heating device in a manner not specifically illustrated. The folding device has folding elements 16, which are provided with a run-on surface 18 and contain clamping elements 20.

The formation of a fold is carried out as follows.

First of all, the strip section 2 is fed over the rail 4 to the supporting elements 6, where it is held by means of the holding elements 10 at two end sections, which correspond to the folding regions of the strip section. Here, the folding regions of the strip sections are initially heated up; this can be carried out as far as close to the melting range of the strip material of the strip section. For example, the heating can amount to 100 to 200° C., 150° C. being preferred.

The folding element 16 has an upsetting edge 22 which, as the figures reveal, interacts with one end of the strip 26 turned over against a supporting surface 24. The supporting surface 24 is prestressed against the folding element 16 by means of a prestressing spring, not specifically illustrated, in order to intensify the engagement of the upsetting edge 22 with the strip 26. Then, as FIG. 4 reveals, the supporting element 6 is drawn back into the initial position, the upsetting edge 22 of the folding element 16 upsetting the projecting strip 26 against a clamping surface 28 of the clamping element 20 and, in the process, forming a definitive fold 30 with the folded edge 32, which lies in the plane of the strip section 2, as revealed by FIGS. 5 and 6. In the process, the fold 30 is clamped in between the clamping surface 28 of the clamping element 20 and the clamping surface 34 of the folding element 16, which is also formed as a clamping element 36 at the same time, said clamping surfaces being aligned virtually in the plane of the strip section 2. The clamping element 36 contains a heating element 40 in order to smooth the fold 30 clamped in between the clamping surfaces 28 and 34 and to fix it in the right form, as emerges from FIG. 7. The clamping and fixing are carried out during the conveying movement of the carousel-like conveying device, not specifically illustrated, from a folding station to a final loading station according to FIG. 8. There, the completely folded strip section 2a is transferred into a magazine 44 of a stacking device by means of a lifting arm or a removal fork 42, with the clamping elements 20, 36 open.

Heating the strip section before folding results in a series of advantages. For example, substantially less heating is needed on the clamping elements 20, 36. This not only takes care of the clamping elements but also reduces the cycle times and, moreover, supplies further-improved folded labels, as has already been explained above.

The thermal pre-treatment of the folding regions of the strip sections to be folded is suitable not only for a folding device according to WO 01/66343, as described in the exemplary embodiment, but also for other folding devices.

List of Designations

2 Strip section
2a Folded strip section
4 Rail
6 Supporting element
8 Folding device
10 Holding element
12 Heating device
14 Visible side
16 Folding element
18 Supporting surface
20 Clamping element
22 Upsetting edge
24 Supporting surface
26 Strip part
28 Clamping surface of 20
30 Definitive fold
32 Folded edge
34 Clamping surface of 36
36 Clamping element
40 Heating element
42 Lifting arm or removal fork
44 Magazine

1-7. (canceled)

8. A method for folding a textile strip section, comprising the steps of:
first feeding the strip section to a supporting element;
initially heating the strip section on a rear side in a region to be folded; and
then folding and finally fixing the strip section in the folded state by pressing and subsequently heating.

9. The method as defined in claim 8, wherein the initial heating step includes heating the folding region approximately up to a softening point of the strip material.

10. A system for folding a textile strip section, comprising:
a folding device; and
a heating device arranged upstream of the folding device so as to heat up a folding region of the strip section, the heating device being arranged to act on a rear side of the strip section.

11. The system as defined in claim 10, and further comprising a supporting element for the strip section arranged on the folding device per folding region.

12. The system as defined in claim 11, and further comprising a holding element assigned to the supporting element and operatively arranged so as to be feedable against the supporting element.

13. The system as defined in claim 12, wherein the holding element also contains an electric heating device.

14. The system as defined in claim 10, and further comprising a feed device for feeding the strip section to the folding device, the feed device having a heating device for heating the folding region of the strip section.
